(19) United States
(12) Patent Application Publication
(10) Pub. No.: US 2006/0133120 A1
(43) Pub. Date: Jun. 22, 2006

(54) Three-phase ac-to-dc-to-ac converter

(75) Inventors: Shinji Sato, Niiza-shi (JP); Fumio Nagamatsu, Niiza-shi (JP); Takahiro Kanata, Niiza-shi (JP); Yuji Fuse, Niiza-shi (JP); Shoichi Kawauchi, Niiza-shi (JP); Osamu Iyama, Niiza-shi (JP)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Sanken Electric Co., Ltd., Niiza-shi (JP)

(21) Appl. No.: 11/302,775

(22) Filed: Dec. 13, 2005

(30) Foreign Application Priority Data
Dec. 17, 2004 (JP) 2004-365502

(51) Int. Cl. H02M 5/45; H02M 5/458

(52) U.S. Cl. 363/37

(57) ABSTRACT

A non-outage power supply system comprises three-phase ac input terminals and three-phase ac output terminals, between which there are sequentially connected a three-phase ac-to-dc converter circuit, a capacitor, and a three-phase dc-to-ac converter circuit. A bypass switch is connected between a preselected one of the three-phase ac input terminals and a preselected one of the three-phase ac output terminals. A bypass switch control circuit holds the bypass switch closed when the three-phase ac inputs are in phase with the three-phase ac outputs, and open when they are not. Part or all of the effective current demanded by the load bypasses the three-phase dc-to-ac converter circuit when the bypass switch is closed, with a consequent reduction of power loss.

### CROSS REFERNCE TO RELATED APPLICATIONS

This application claims priority to Japanese Patent Application No. 2004-365502, filed Dec. 17, 2004.

### BACKGROUND OF THE INVENTION

This invention relates to power converters, and particularly to those capable of three-phase ac-to-dc, and back to three-phase ac, conversion.

Japanese Unexamined Patent Publication No. 2000-116137 teaches a three-phase power converter that is believed by this applicant to be closest to the instant invention. This prior art power converter comprises a three-phase ac-to-dc converter circuit connected to a set of three-phase ac inputs via inductors, a capacitor connected between the pair of dc outputs of the three-phase ac-to-dc converter circuit, and a three-phase dc-to-ac converter circuit connected between the capacitor and a set of three-phase ac outputs.

The three-phase ac-to-dc converter circuit comprises six diodes in three-phase bridge connection and six ac-to-dc conversion switches connected reversely in parallel with the respective diodes. The three phase dc-to-ac converter circuit, or three-phase inverter circuit, comprises six dc-to-ac conversion switches in three-phase bridge connection and six feedback diodes connected reversely in parallel with the respective switches. Both ac-to-dc converter circuit and dc-to-ac converter circuit use the familiar pulse width modulation (PWM) for on/off control of the switches.

There have been some problems left unresolved with the prior art three-phase power converter outlined above, causing a substantive diminution of its efficiency. One of the problems is that the six switches of the dc-to-ac converter circuit have incurred a considerable power loss, due to both switching and conduction losses, when the input three-phase ac voltages are wholly directed through these switches, as has been the practice heretofore. The switching loss taking place when all the six switches of the ac-to-dc converter circuit are PWM driven represents another problem of the prior art that must also be overcome for provision of a truly efficient three-phase power converter.

### SUMMARY OF THE INVENTION

The present invention seeks, in a three-phase power converter of the kind defined, to reduce power loss to a minimum by defeating the problems pointed out above.

Stated in brief, the invention concerns a three-phase ac-to-dc-to-ac power converter system having a first, a second and a third ac input terminal for inputting a first-, a second- and a third-phase ac voltage, and a first, a second and a third ac output terminal for outputting a first-, a second- and a third-phase ac voltage. Sequentially connected between the three-phase ac input terminals and the three-phase ac output terminals are a three-phase ac-to-dc converter circuit comprising a plurality of ac-to-dc conversion switches for translating the three-phase ac input voltages into a dc voltage, storage means such as a capacitor for storing the dc voltage, and a three-phase dc-to-ac converter circuit comprising a plurality of dc-to-ac conversion switches for translating the dc voltage into the three-phase ac output voltages. Also included, according to a feature of the invention, is a bypass switch connected between a preselected one of the ac input terminals and a preselected one of the ac output terminals. Control means are provided which include ac-to-dc converter control means connected to the three-phase ac-to-dc converter circuit for controllably driving the ac-to-dc conversion switches thereof, dc-to-ac converter control means connected to the three-phase dc-to-ac converter circuit for controllably driving the dc-to-ac conversion switches thereof either in or out of synchronism with the three-phase ac input voltages, and bypass switch control means connected to the bypass switch for holding the same closed when the three-phase dc-to-ac converter circuit is being driven in synchronism with the three-phase ac input voltages, and open when the three-phase dc-to-ac converter circuit is being driven out of synchronism with the three-phase ac input voltages.

Thus, closed when the three-phase dc-to-ac converter circuit is driven in synchronism with the three-phase ac input voltages, the bypass switch provides a bypass connection between the preselected ac input terminal and the preselected ac output terminal. Let it be supposed for instance that the bypass switch has directly connected the first ac input terminal and first ac output terminal. Then the effective current demanded by the loaded connected to the first ac output terminal will be supplied, either in part or in whole, along the path comprising the first ac input terminal, bypass switch, and first ac output terminal, bypassing the three-phase dc-to-ac converter circuit. All or part of the effective current need not be supplied through the first-phase dc-to-ac converter switches of the three-phase dc-to-ac converter circuit to which is connected the first ac output terminal. Power loss through these switches is therefore avoided, realizing an improvement in the efficiency of the three-phase ac-to-dc-to-ac power converter system.

The three-phase ac input voltages may suffer a frequency deviation while the three-phase ac output voltages from the three-phase dc-to-ac converter circuit are fixed in frequency. Then the bypass switch will be opened, and the three-phase dc-to-ac converter circuit driven out of synchronism with the three-phase ac input voltages. Both three-phase ac-to-dc converter circuit and three-phase dc-to-ac converter circuit can therefore be maintained in operation for uninterrupted power supply.

The above and other objects, features and advantages of this invention will become more apparent, and the invention itself will best be understood, from a study of the following description and appended claims, with reference had to the attached drawings showing some preferable embodiments of the invention.

### BRIEF DESCRIPTION OF THE DRAWINGS

FIG. 1 is a block diagram of a three-phase power converter system embodying the principles of this invention.

FIG. 2 is a schematic electrical diagram of the three-phase ac-to-dc converter circuit, three-phase dc-to-ac converter circuit, and associated parts of the three-phase power converter system.

FIG. 3 is a block diagram showing in more detail the control circuit of the three-phase power converter system.

FIG. 4 is a block diagram showing in more detail the bypass switch control and phase select circuit included in the control circuit of FIG. 3.

FIG. 5 is a schematic electrical diagram of the ac-to-dc control signal generator circuit and dc-to-ac control signal generator circuit included in the control circuit of FIG. 3, together with the first and second driver circuits of FIG. 1.

FIG. 6, consisting of (A) through (F), is a wave diagram useful in explaining the operation of the three-phase power converter system of FIG. 1.

FIG. 7 is a schematic electrical diagram of a modification of the ac-to-dc converter control circuit of FIG. 3.

### DESCRIPTION OF THE PREFERRED EMBODIMENTS

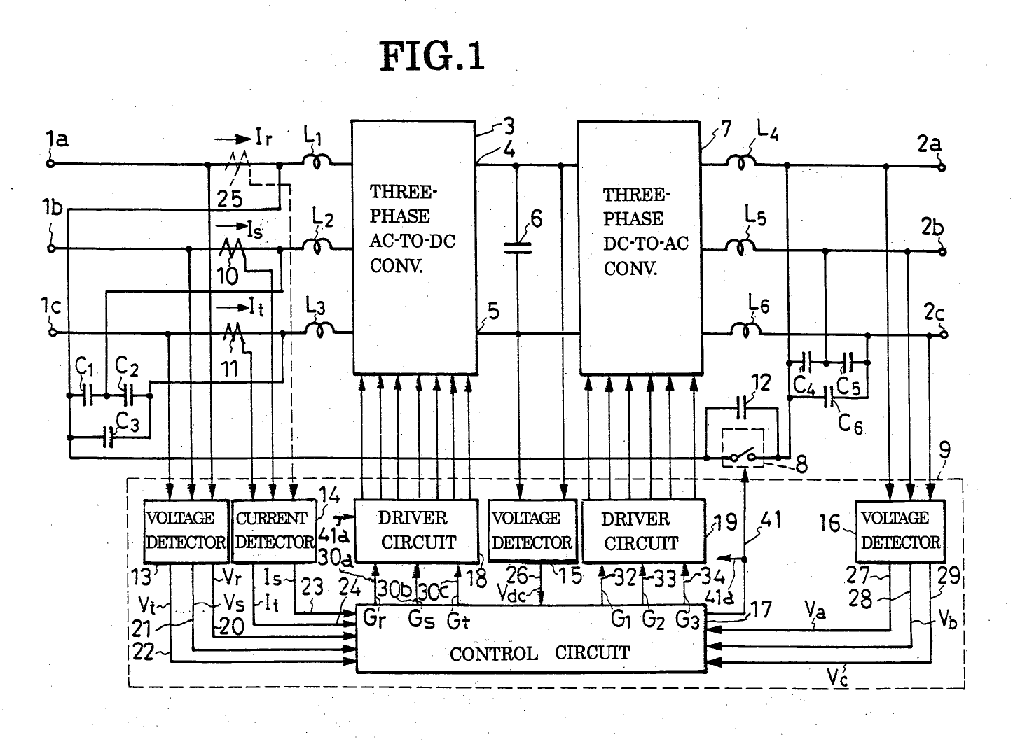

The present invention is currently believed to be best embodied in the three-phase power converter system diagramed in FIG. 1. The illustrated power converter system, or uninterruptible power supply, as it may also be called, broadly comprises:

1. Three ac input terminals 1ₐ, 1_{b} and 1_{c} for inputting three-phase ac voltages.

2. Three ac output terminals 2ₐ, 2_{b} and 2_{c} for outputting three-phase ac voltages.

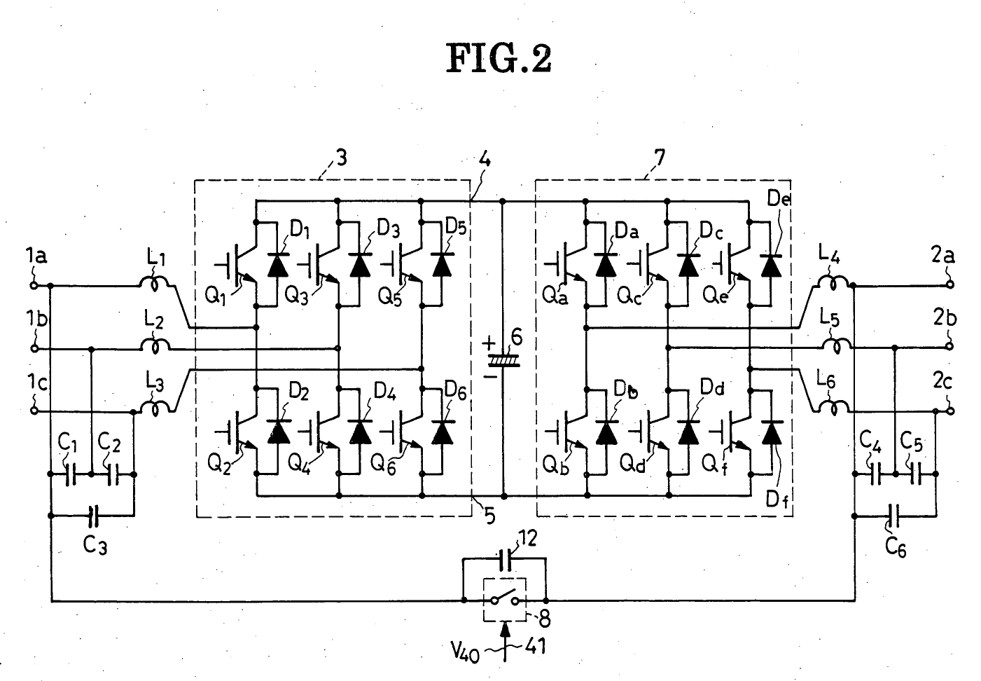

3. A three-phase ac-to-dc converter circuit 3 (shown in detail in FIG. 2) connected to the ac input terminals 1ₐ-1_{c.}

4. A dc link, or smoothing, capacitor 6 connected between the pair of output terminals 4 and 5 of the ac-to-dc converter circuit 3.

5. A three-phase dc-to-ac converter circuit 7 (shown in detail in FIG. 2) connected between the capacitor 6 and the ac output terminals 2ₐ-2_{c}.

6. A bypass switch 8 connected between any, shown as 1ₐ, of the three ac input terminals 1ₐ-1_{c} and any, shown as 2ₐ, of the three ac output terminals 2ₐ-2_{c} for synchronizing the dc-to-ac converter circuit 7 with the three-phase ac input voltages.

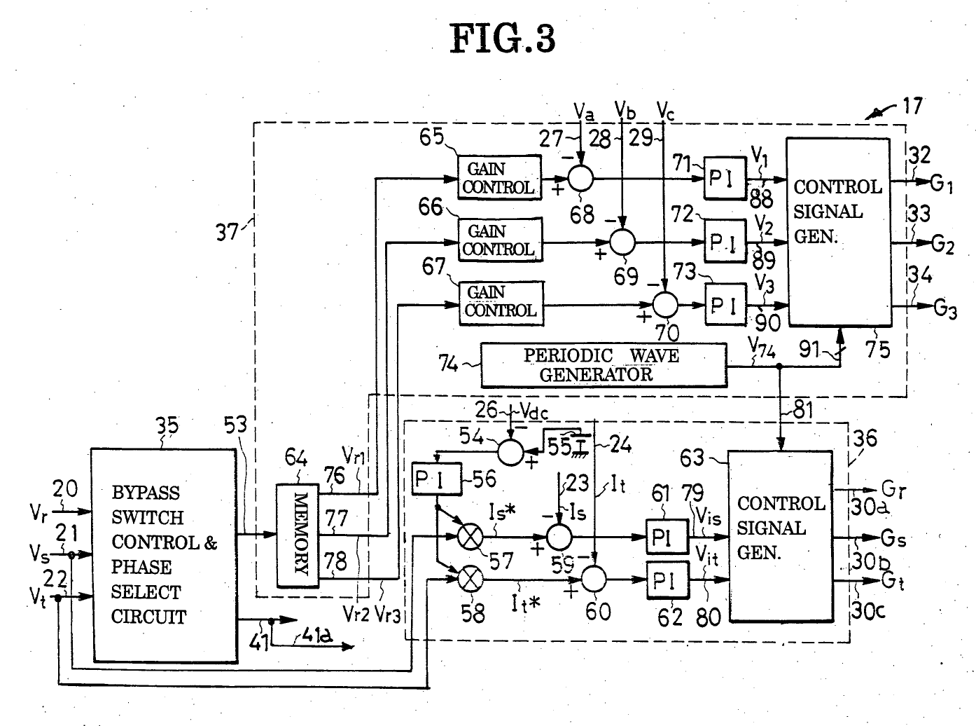

7. Control means 9 (shown in detail in FIGS. 3-5) for controllably driving the three-phase ac-to-dc converter circuit 3 and three-phase dc-to-ac converter circuit 7 and for holding the bypass switch 8 closed when the dc-to-ac converter circuit 7 is being driven in synchronism with the three-phase ac input voltages, and open when the dc-to-ac converter circuit 7 is being driven out of synchronism with the three-phase ac input voltages.

8. Three capacitors C₁-C₃ for filtering out high frequency components from the input currents.

9. Another three capacitors C₄-C₆ for filtering out high frequency components from the output currents.

10. Three inductors L₁-L₃ connected respectively between the ac input terminals 1ₐ-1_{c} and the ac-to-dc converter circuit 3.

11. Another three inductors L₄-L₆ connected respectively between the dc-to-ac converter circuit 7 and the ac output terminals 2ₐ-2_{c}.

12. Second (S) and third (T) phase current detectors 10 and 11 coupled, either electrically or electromagnetically, to the lines between the second and third ac input terminals 1_{b} and 1_{c} and the second and third capacitors C₂ and C₃, although these current detectors might be considered parts of the control means 9.

13. A capacitor 12 connected in parallel with the bypass switch 8.

Coupled for example to a commercial fifty-hertz three-phase ac power supply, the ac input terminals 1ₐ-1_{c} input three ac voltages having phase differences of 120 degrees from one another.

Reference may be had to FIG. 2 for a closer study of the three-phase ac-to-dc converter circuit 3. This circuit 3, which might also be termed a three-phase switching rectifier circuit or PWM rectifier circuit, comprises six diodes D₁-D₆ in three-phase bridge connection and as many ac-to-dc conversion switches Q₁-Q₆ connected in parallel with the respective diodes D₁-D₆. The ac-to-dc conversion switches Q₁-Q₆ are shown as insulated-gate bipolar transistors, although they could be other semiconductor switches including field-effect transistors and other transistors. The diodes D₁-D₆ need not necessarily be discrete units as shown, either, but could instead be inbuilt, or “parasitic,” diodes of the semiconductor switches employed for ac-to-dc conversion.

The first, third and fifth diodes D₁, D₃ and D₅ of the ac-to-dc converter circuit 3 have their anodes connected respectively to the three ac input terminals 1ₐ-1_{c} via the three inductors L₁-L₃, and their cathodes connected all to the positive terminal of the capacitor 6 via the positive output 4 of the ac-to-dc converter circuit 3. The second, fourth and sixth diodes D₂, D₄ and D₆ of the ac-to-dc converter circuit 3 have their anodes connected to the negative terminal of the capacitor 6 via the negative output 5 of the ac-to-dc converter circuit, and their cathodes connected respectively to the three ac input terminals 1ₐ-1_{c} via the three inductors L₁-L₃.

Connected between the pair of outputs 4 and 5 of the ac-to-dc converter circuit 3, the capacitor 6 as the storage means is charged by the output from this circuit to serve as a dc power supply for the dc-to-ac converter circuit 7. As desired or required, a battery could be connected in parallel with, or in substitution for, the capacitor 6. Still further, as additional alternatives, a reverse-blocking diode might be connected in series with the battery, or a charging circuit might be connected to the battery.

As shown also in FIG. 2, the three-phase dc-to-ac converter circuit 7 comprises six dc-to-ac conversion switches Qₐ-Q_{f} in three-phase bridge connection and as many feedback diodes Dₐ-D_{f} connected in parallel with the respective switches. The dc-to-ac conversion switches Qₐ-Q_{f} are shown as insulated-gate bipolar transistors but could be other semiconductor switches including field-effect transistors and other transistors. Also, here again, the feedback diodes Dₐ-D_{f} need not necessarily be discrete units but could be inbuilt, or “parasitic,” diodes of the semiconductor switches employed for dc-to-ac conversion.

The first, third and fifth dc-to-ac conversion switches Qₐ, Q_{c} and Qₑ of the dc-to-ac converter circuit 7 have their collectors connected all to the positive terminal of the capacitor 6, and their emitters connected respectively to the three ac output terminals 2ₐ-2_{c} via the three inductors L₄-L₆. The second, fourth and sixth dc-to-ac conversion switches Q_{b}, Q_{d} and Q_{f} have their collectors connected respectively to the ac output terminals 2ₐ-2_{c} via the inductors L₄-L₆, and their emitters connected all to the negative terminal of the capacitor 6.

Inserted respectively between the three ac input terminals 1ₐ-1_{c} and the ac-to-dc converter circuit 3, the three inductors L₁-L₃ are intended for improvements in input current waveform and power factor, as well as for elimination from the input currents of the high-frequency components due to PWM control by the ac-to-dc converter circuit 3. These inductors L₁-L₃, however, need not be discrete units as shown but are replaceable by ac conductors having parasitic inductances. The capacitors C₁-C₃ are connected one between every two of the ac input terminals 1ₐ-1_{c}. These capacitors are also intended for elimination from the input currents of the high-frequency noise due to PWM control by the ac-to-dc converter circuit 3.

The other three inductors L₄-L₆ are interposed between the dc-to-ac converter circuit 7 and the respective ac output terminals 2ₐ-2_{c} for reshaping the output voltages, which have been PWM controlled by the dc-to-ac converter circuit, into sinusoidal waveform by filtering out the high frequency noise therefrom. These inductors L₄-L₆, shown as discrete units, are also replaceable by ac lines having parasitic inductances. The other three capacitors C₄-C₆, connected one between every two of the ac output terminals 2ₐ-2_{c} also serve for removal of high frequency components from the output voltages of the dc-to-ac converter circuit 7.

The input and output high-frequency filter means set forth in the foregoing, shown in FIGS. 1 and 2 as being constituted of the six inductors L₁-L₆ and six capacitors C₁-C₆, are variously modifiable within the broad teaching hereof. One such possible modification is to omit the six filtering capacitors C₁-C₆ altogether.

The bypass switch 8 is shown in both FIGS. 1 and 2 as being connected between the first ac input terminal 1ₐ and the first ac output terminal 2ₐ. Alternatively, however, this switch 8 is connectable between any other combinations of one ac input terminal and one ac output terminal. While the bypass switch 8 may be of either semiconductor or mechanical type, a controllable mechanical switch is preferred because it makes the converter less expensive in construction and more efficient in operation. If a semiconductor switch is to be employed, it may take the form of an ac switching circuit using two thyristors or two insulated-gate bipolar transistors.

The bypass switch 8 when closed causes the ac-to-dc converter circuit 7 to be driven in synchronism with the three-phase ac input voltages. When open, on the other hand, the bypass switch 8 causes the ac-to-dc converter circuit 7 to be driven independently of the three-phase ac input voltages. Connected in parallel with the bypass switch 8, the ac capacitor 12 serves mostly for noise reduction.

With reference back to FIG. 1 the control means 9 are constituted of the following components for controlling the ac-to-dc converter circuit 3, dc-to-ac converter circuit 7, and bypass switch 8:

1. An input voltage detector circuit 13 for providing three-phase ac input voltage detect signals Vᵣ, Vₛ and Vₜ indicative of the incoming three-phase ac input voltages.

2. An input current detector circuit 14 for detecting the S- and T-phase currents Iₛ and Iₜ from the second and third ac input terminals 1_{b} and I_{c}.

3. A dc voltage detector circuit 15 for detecting the voltage across the capacitor 6.

4. An output voltage detector circuit 16 for providing three-phase ac output voltage detect signals Vₐ, V_{b} and V_{c} indicative of the outgoing three-phase ac output voltages.

5. A control circuit 17 for generating control signals in response to the outputs from the input voltage detector circuit 13, input current detector circuit 14, dc voltage detector circuit 15, and output voltage detector circuit 16.

6. A first driver circuit 18 for controllably driving the three-phase ac-to-dc converter circuit 3 as dictated by the control signals from the control circuit 17.

7. A second driver circuit 19 for controllably driving the three-phase dc-to-ac converter circuit 7 as dictated by the control signals from the control circuit 17.

The input voltage detector circuit 13 is connected to the three ac input terminals 1ₐ-1_{c} for detecting the R-, S- and T-phase ac input voltages. The outputs Vᵣ, Vₛ and Vₜ from the input voltage detector circuit 13 are sent over lines 20-22 to the control circuit 17.

The input current detector circuit 14 has inputs connected respectively to the S- and T-phase current detectors 10 and 11 which in turn are coupled, either electrically or electromagnetically, to the lines between the second and third ac input terminals 1_{b} and 1_{c} and the second and third capacitors C₂ and C₃. Detecting the S- and T-phase currents Iₛ and Iₜ flowing through the second and third ac input terminals 1_{b} and 1_{c}, the input current detector circuit 14 delivers the resulting current detect signals to the control circuit 17 over the lines 23 and 24. The alternating currents flowing through the second and third ac input terminals 1_{b} and 1_{c} and the ac input current detect signals from the current detector circuit 14 are designated by the same reference characters Iₛ and Iₜ in FIG. 1 for the ease of understanding. The input current detector circuit 14 will be unnecessary in cases where the current detectors 10 and 11 suffice to provide the S- and T-phase current signals Iₛ and Iₜ.

The dc voltage detector circuit 15 is connected across the capacitor 6 for providing a dc voltage detect signal V_{dc} indicative of the dc voltage across the capacitor. The dc voltage detect signal V_{dc} is fed to the control circuit 17 over a line 26. The dc voltage detector circuit 15 might be considered a part of an ac-to-dc converter control circuit 36, FIG. 3, included in the control circuit 17.

The output voltage detector circuit 16 has inputs connected respectively to the three ac output terminals 2ₐ-2_{c} for providing signals representative of the three-phase ac output voltages Vₐ, V_{b} and V_{c}. These output voltage detect signals are sent over lines 27-29 to the control circuit 17. This output voltage detector circuit 16 could also be considered a part of a dc-to-ac conversion control circuit 37, FIG. 3, included in the control circuit 17.

The first driver circuit 18 have inputs connected to the control circuit 17 by way of lines 30ₐ, 30_{b} and 30_{c} and outputs connected to the ac-to-dc converter circuit 3. Inputting three-phase ac-to-dc conversion control signals Gᵣ, Gₛ, and Gₜ from the control circuit 17 over the lines 30ₐ, 30_{b} and 30_{c}, the first driver circuit 18 creates switch control signals for application to the control terminals (gates) of the ac-to-dc conversion switches Q₁-Q₆, FIG. 2, of the ac-to-dc converter circuit 3. The second, fourth and sixth switches Q₂, Q₄ and Q₆ are turned on and off in alternation with the first, third and fifth switches Q₁, Q₃ and Q₅. This first driver circuit 18 could also be included in the ac-to-dc converter control circuit 36, FIG. 3, of the control circuit 17.

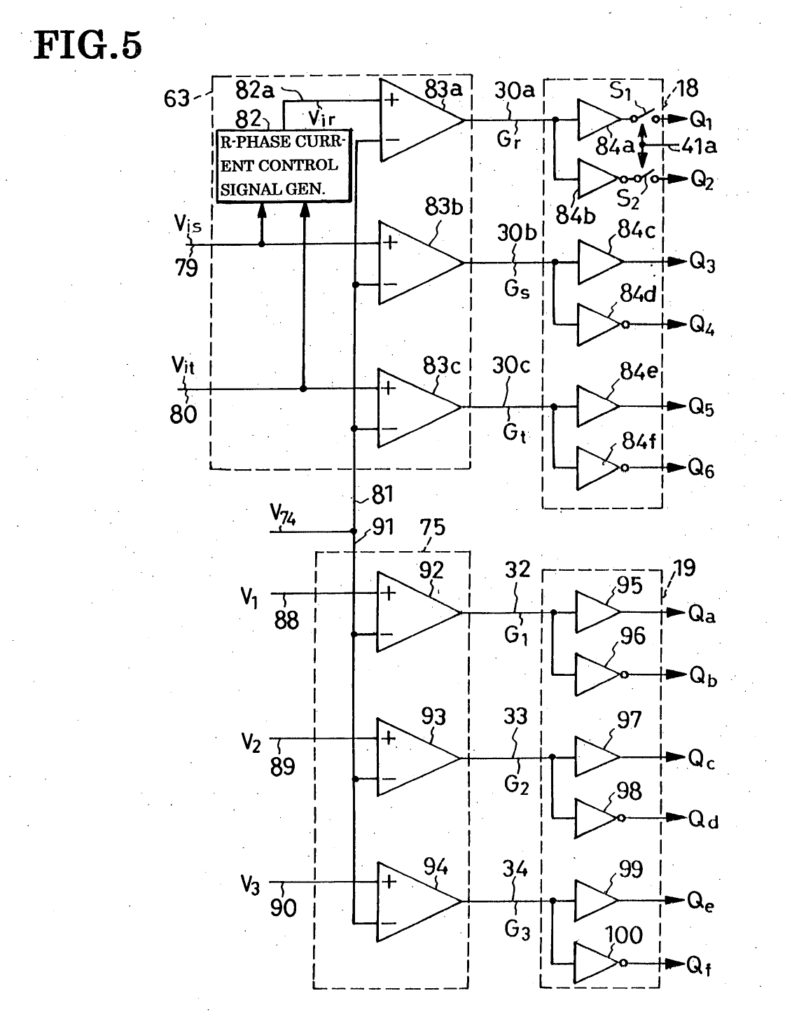

The first driver circuit 18 is designed to keep nonconducting the first and second switches Q₁ and Q₂ of the ac-to-dc converter circuit 3 during the conducting periods of the bypass switch 8. Toward this end the first driver circuit 18 is connected by way of a line 41ₐ to the same output of the control circuit 17 as that connected to the bypass switch 8 by way of the line 41. The first driver circuit 18 will be later detailed with reference to FIG. 5.

The second driver circuit 19 is connected between control circuit 17 and dc-to-ac converter circuit 7. Inputting three-phase dc-to-ac conversion control signals G₁, G₂ and G₃ from the control circuit 17 over lines 32, 33 and 34, the second driver circuit 19 creates switch control signals for application to the control terminals (gates) of the dc-to-ac conversion switches Qₐ-Q_{f}, FIG. 2, of the dc-to-ac converter circuit 7. The first, third and fifth dc-to-ac conversion switches Qₐ, Q_{c} and Qₑ are conventionally turned on and off in alternation with the second, fourth and sixth switches Q_{b}, Q_{d} and Q_{f}. The second driver circuit 19 might be considered a part of the dc-to-ac converter control circuit 37, FIG. 3, of the control circuit 17.

The control circuit 17 is further connected as above mentioned to the control terminal of the bypass switch 8 by way of the line 41. The bypass switch 8 is turned on when the detected input frequency is in synchronism with the desired output frequency, and off when it is not, according to the novel concepts of this invention, as will be better understood as the description progresses.

FIG. 3 is a detailed, though still partly block-diagrammatic, illustration of the control circuit 17. Broadly, the control circuit 17 is divisible into a bypass switch control and phase select circuit 35, an ac-to-dc converter control circuit 36, and a dc-to-ac converter control circuit 37. The bypass switch control and phase select circuit 35 performs the functions of delivering the signal to the bypass switch 8 over the line 41 and of sending over a line 53 the phase signal needed for driving both ac-to-dc converter circuit 3 and dc-to-ac converter circuit 7.

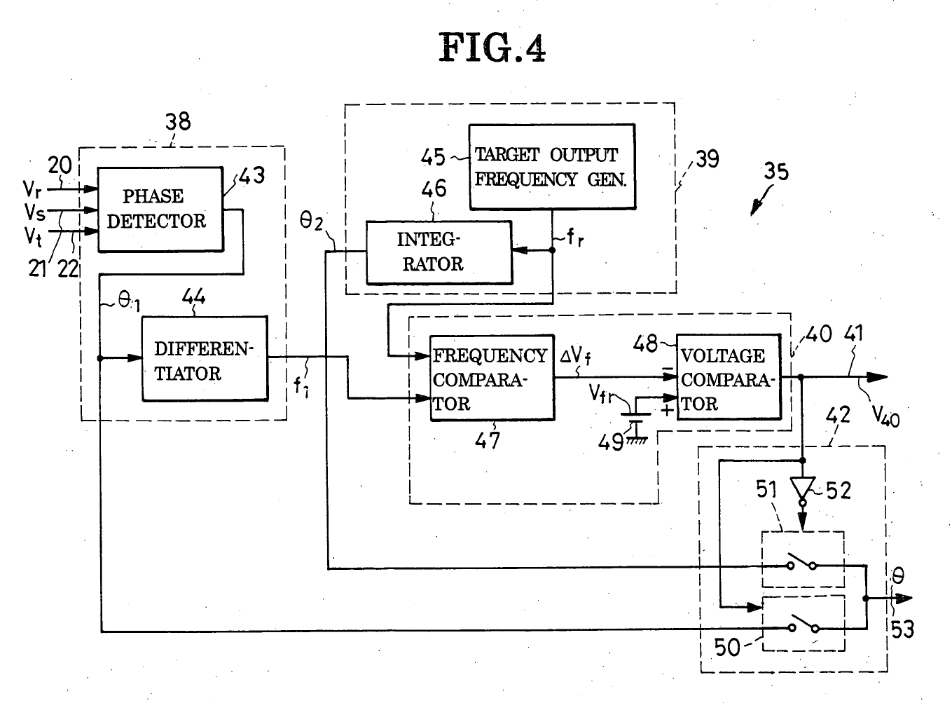

As illustrated in more detail in FIG. 4, the bypass switch control and phase select circuit 35 comprises:

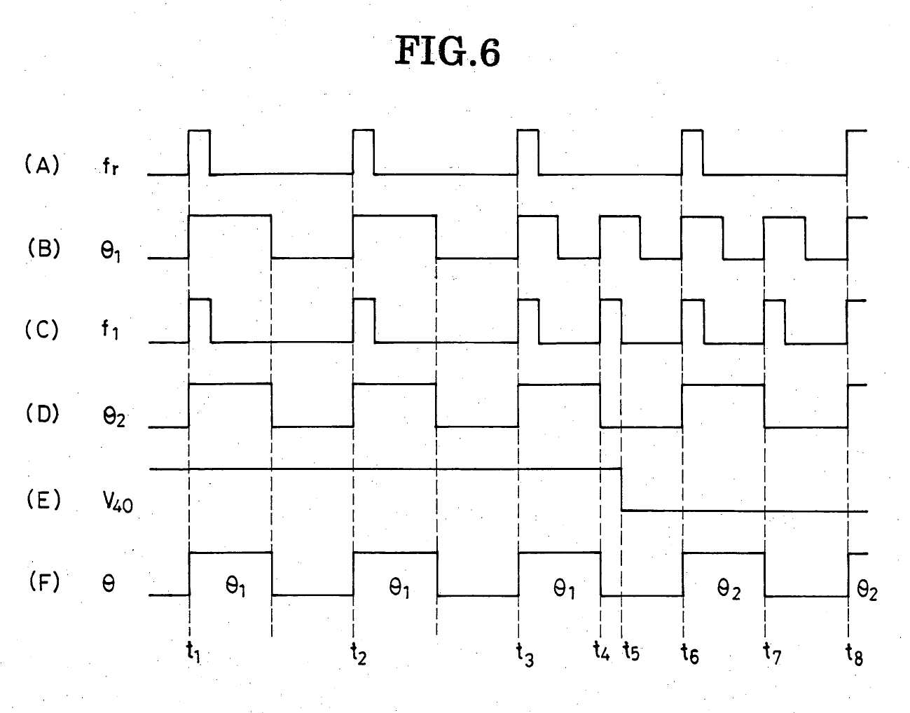

1. Input parameter detector means 38 for providing both ac input phase signal θ₁, shown at (B) in FIG. 6, and ac input voltage frequency signal f₁, (C) in FIG. 6.

2. Target output parameter generator means 39 for providing a target output frequency signal fᵣ, (A) in FIG. 6, and a target output phase signal θ₂, (D) in FIG. 6.

3. Comparison means 40 for ascertaining synchronism between three-phase ac input voltages and output voltages and providing a bypass switch control signal V₄₀, (E) in FIG. 6, for application to the bypass switch 8, FIG. 1, over the line 41.

4. Selector means 42 responsive to the bypass switch control signal V₄₀ from the comparison means 40 for selectively passing the ac input phase signal θ from the input parameter detector means 38 and the target output phase signal θ₂ from the target output parameter generator means 39, for delivery over the line 53 to the dc-to-ac converter control circuit 37 of the control circuit 17 seen in FIG. 3.

The input parameter detector means 38 of the bypass switch control and phase select circuit 35 comprise a phase detector 43 connected to the input voltage detector 13, FIG. 1, of the control means 9 by way of the lines 20-22, and a differentiating circuit 44 connected to the output of the phase detector 44. The phase detector 43 relies on a selected one of the incoming three-phase ac voltages for providing the noted ac input phase signal θ₁ indicative of the phase of the selected ac input voltage. Alternatively, however, there may be created signals indicative of the phases of all the three-phase ac input voltages. The ac input phase signal θ has the same period as the ac input voltage. The input voltage detector 13 could be included in the input parameter detector means 38.

The ac input phase signal θ₁ is applied to the differentiating circuit 44 besides being delivered to the selector means 42. Differentiating the ac input phase signal θ₁, the differentiating circuit 44 puts out the ac input voltage frequency signal f₁ as the input parameter. Despite the showing of FIG. 4, however, the production of both ac input phase signal θ₁ and frequency signal f₁ is not an absolute requirement. Some applications of the invention may demand only either of these signals, in which case the input parameter detector means may be constituted solely of the phase detector 43 or a frequency detector. The input parameter is an input phase signal when the input parameter detector means is a phase detector. The input parameter is an input voltage frequency signal when the input parameter detector means is a frequency detector.

The target output parameter generator means 39 of the bypass switch control and phase select circuit 35 comprise a target output frequency generator 45 and an integrating circuit 46. The target output frequency generator 45 puts out the signal representative of a target output frequency fᵣ at which the three-phase dc-to-ac converter circuit 7, FIG. 1, should provide the ac output voltages. The target output frequency fᵣ is fixed, for example at 50 hertz, in this embodiment of the invention. The target output frequency signal as the target output parameter is delivered both to the integrating circuit 46 and to the comparison means 40. The integrating circuit 46 creates the target output phase signal θ₂ from the target output frequency signal. A comparison of (A) and (D) in FIG. 6 will indicate that the target output phase signal θ₂ has the same period as the target output frequency fₜ.

Since the comparison means 40 and selector means 42 are both configured to demand signals representative of only one of the three phases in this embodiment of the invention, the target output parameter generator means 39 provide the signals for only one phase. However, the target output parameter generator means 39 may be modified to put out three-phase signals in cases where the comparison means 40 and selector means 42 are also modified to demand such signals. Possibly, the comparison means 40 and selector means 42 may be modified to demand only either of the target output frequency fᵣ and target output phase signal θ₂. In that case the target output parameter generator means 39 may be correspondingly altered to provide the required frequency or phase signal. The target output parameter is a target output frequency when the target output parameter generator means is a target output frequency generator. The target output parameter is a target output phase signal when the target output parameter generator means is a target output phase signal generator.

The comparison means 40 of the bypass switch control and phase select circuit 35 are designed to determine whether the three-phase ac input voltages from the input terminals 1ₐ-1_{c} are in or out of phase with the three-phase ac output voltages being produced by the dc-to-ac converter circuit 7. Employed to this end are a frequency comparator 47 and volt-age comparator 48.

The frequency comparator 47 of the comparison means 40 has one input connected to the differentiating circuit 44 of the input parameter detector means 38 and another input to the target output frequency generator 45 of the target output parameter generator means 39. Thus the frequency comparator compares the target output frequency fᵣ, (A) in FIG. 6, and the ac input voltage frequency f₁, (C) in FIG. 6, and puts out a voltage signal indicative of the absolute value of the difference between the two inputs.

The voltage comparator 48, the other component of the comparison means 40, has one input connected to the frequency comparator 47 and another input to a reference voltage source 49. The reference voltage V_{fr} from the source 49 represents the maximum of the allowable frequency deviation ΔV_{f} for synchronous operation of the dc-to-ac converter circuit 7. The output (bypass switch control signal) V₄₀ from the voltage comparator 48 has one prescribed state (high in this embodiment) when the absolute value of the frequency deviation ΔV_{f} is less than the reference voltage V_{fr} and another prescribed state (low) when otherwise. The comparator output or bypass switch control signal V₄₀ holds the bypass switch 8 closed when in the first prescribed state and open when in the second prescribed state.

The illustrated comparison means 40 permits a modification in which a phase comparator is used in substitution for the frequency comparator 47. The phase comparator may compare the ac input phase signal θ₁ from the phase detector 43 of the input parameter detector means 38 and the target output phase signal θ₂ from the integrating circuit 46 of the target output parameter generator means 39. Another possible modification is to replace the voltage comparator 48 and reference voltage source 49 by an inverting, or noninverting, amplifier or NOT circuit or the like having a threshold value that is functionally equivalent to the reference voltage V_{fr}. A binary output similar to that from the illustrated comparison means 40 will be obtained by thus utilizing the threshold value in lieu of the reference voltage V_{fr}.

The voltage comparator 48 of the comparison means 40 has its output connected by way of the line 41 to the control terminal of the bypass switch 8, FIGS. 1 and 2, for application of the switch control signal V₄₀. A switch driver circuit might be inserted between voltage comparator 48 and bypass switch 8.

With continued reference to FIG. 4 the selector means 42 of the bypass switch control and phase select circuit 35 comprise two on/off switches 50 and 51 and an inverter circuit 52. The first switch 50 is under the direct control of the voltage comparator 48 of the comparison means 42. The second on-off switch 51 is under the control of the voltage comparator 48 via the inverter circuit 52. Connected to the phase detector 43 of the input parameter detector means 38, the first switch 50 passes the ac input phase signal 0, when the bypass switch control signal V₄₀ is high. The second switch 51 is connected to the integrating circuit 46 of the target output parameter generator means 39 for passing the target output phase signal θ₂ when the bypass switch control signal is low. The selected ac input phase signal θ₁ or target output phase signal θ₂, comprehensively designated θ and shown at (F) in FIG. 6, is sent over the line 53 to the dc-to-ac converter control circuit 37, FIG. 3, of the control circuit 17.

As has been mentioned, the ac-to-dc converter control circuit 36 and dc-to-ac converter control circuit 37 of FIG. 3 are both modifiable to input frequency signals rather than the phase signals as in the present embodiment of the invention. In that case the first switch 50 of the selector means 42 may be connected to the differentiating circuit 44 of the input parameter detector means 38, and the second switch 51 to the target output frequency generator 45.

With reference back to FIG. 3 the ac-to-dc converter control circuit 36 comprises:

1. A subtractor 54 for computing a difference between the dc voltage detect signal V_{dc} indicative of the actual voltage across the capacitor 6, FIG. 1, and a reference voltage indicative of a desired voltage across the capacitor.

2. A proportional integrator (PI) 56 connected to the subtractor 54 for providing a dc voltage control signal.

3. An S-phase multiplier 57 and T-phase multiplier 58 each having an input connected to the second or third phase voltage line 21 or 22 and another input connected to the proportional integrator 56.

4. An S-phase current control subtractor 59 and T-phase current control subtractor 60 each having one input connected to the S- or T-phase multiplier 57 or 58 and another input connected to the S- or T-phase input current detect lines 23 and 24.

5. An S-phase proportional integrator 61 and T-phase proportional integrator 62 connected respectively to the S- and T-phase subtractors 59 and 60.

6. An ac-to-dc converter control signal generator circuit 63 connected to the proportional integrators 61 and 62 and a periodic wave generator 74, shown included in the dc-to-ac converter control circuit 37, for generating pulse-width-modulated ac-to-dc converter control signals Gᵣ, Gₛ and Gₜ for delivery over the lines 30ₐ-30_{c} to the first driver circuit 18, FIG. 1, in order to cause the same to drive the switches Q₁-Q₆, FIG. 2, of the ac-to-dc converter circuit 3 accordingly.

The periodic wave generator 74 is shown included in the dc-to-ac converter control circuit 37 for illustrative convenience only. In fact, being shared by both ac-to-dc converter control circuit 36 and dc-to-ac converter control circuit 37, the periodic wave generator 74 could be shown external to both these circuits 36 and 37 or contained in the circuit 36, or another such generator provided in this circuit 36. The periodic wave generator 74 may generate either triangular or sawtooth waves, with a frequency higher than that of the three-phase ac input voltages.

The subtractor 54 of the ac-to-dc converter control circuit 36 has one input connected to the dc voltage detect line 26 from the voltage detector 15, FIG. 1, and another input connected to a source 55 of a reference voltage representative of the desired voltage across the capacitor 6. Thus the subtractor 54 provides a signal indicative of the difference between the actual and desired voltages across the capacitor 6. The subtractor 54 is replaceable by an adder, with the two inputs to the adder made opposite in polarity.

Connected to the subtractor 54, the proportional integrator 56 puts out a dc voltage control signal formed by smoothing with a prescribed time constant the output from the subtractor. Since the ac input currents are processed into sinusoidal waves in this embodiment of the invention, the dc voltage control signal might also be called a current amplitude control signal. Further the subtractor 54 and proportional integrator 56 might be integrated into what might be termed a dc voltage control circuit.

For controlling the third to sixth switches Q₃-Q₆, FIG. 2, of the ac-to-dc converter circuit 3, the S- and T-phase multipliers 57 and 58 of the ac-to-dc converter control circuit 36 have inputs connected to the voltage detector 13, FIG. 1, by way of the lines 21 and 22, inputting the second and third phase voltage detect signals Vₛ and Vₜ, respectively. The other inputs of these multipliers 57 and 58 are both connected to the proportional integrator 56. The multipliers 57 and 58 put out S- and T-phase target ac waveform signals Iₛ* and Iₜ* by modulating the amplitudes of the incoming second and third phase voltage detect signals Vₛ and Vₜ with the output from the proportional integrator 56.

Connected to the outputs of the multipliers 57 and 58, the S- and T-phase current control subtractors 59 and 60 put out signals indicative of the differences between the S- and T-phase target ac waveform signals Iₛ* and Iₜ* and the S- and T-phase input current detect signals Iₛ and Iₜ from the current detector 14, FIG. 1.

The difference signals from the current control subtractors 59 and 60 are fed respectively to the S- and T-phase proportional integrators 61 and 62 thereby to be smoothed into S- and T-phase current control signals Vᵢₛ and Vᵢₜ on their output lines 79 and 80. These current control signals Vᵢₛ and Vᵢₜ determine the pulse durations. Despite the showing of FIG. 3 the subtractors 59 and 60 and proportional integrators 61 and 62 could be of integral construction. Further the subtractors 59 and 60 might be replaced by adders, provided that the input signals to each adder were made opposite in polarity. In short the subtractors 59 and 60 are variously modifiable toward the ultimate aim of obtaining the current control signals Vᵢₛ and Vᵢₜ indicative of the differences between input current detect signals Iₛ and Iₜ and target ac waveform signals Iₛ* and Iₜ*.

The ac-to-dc converter control signal generator circuit 63 has inputs connected to the proportional integrator 61 and 62 by way of the lines 79 and 80 and another input connected by way of a line 81 to the periodic wave generator 74 which is shown included in the dc-to-ac converter control circuit 37. The periodic wave V₇₄ from the periodic wave generator 74 may be either a triangular or sawtooth wave, higher in frequency than the three-phase ac input voltages. Inputting the S- and T-phase current control signals Vᵢₛ and Vᵢₜ and periodic wave V₇₄, the ac-to-dc converter control signal generator circuit 63 puts out the three-phase, pulse-width-modulated, ac-to-dc converter control signals Gᵣ, Gₛ and Gₜ. These ac-to-dc converter control signals are sent over the lines 30ₐ, 30_{b} and 30_{c} to the driver circuit 18, FIG. 1, thereby causing the same to controllably drive the switches Q₁-Q₆, FIG. 2, of the ac-to-dc converter circuit 3, as has been known heretofore.

Reference may be had to FIG. 5 for a more detailed study of the ac-to-dc converter control signal generator circuit 63. Included is an R-phase current control signal generator circuit 82 which is connected to the proportional integrators 61 and 62, FIG. 3, by way of the lines 79 and 78 for inputting the S- and T-phase current control signals Vᵢₛ and Vᵢₜ. The R-phase current control signal generator circuit 82 puts out an R-phase current control signal Vᵢᵣ by computing −(Vᵢₛ+Vᵢₜ).

The ac-to-dc converter control signal generator circuit 63 further comprises R-, S- and T-phase comparators 83ₐ, 83_{b} and 83_{c}. The R-phase comparator 83ₐ has one input connected to the R-phase current control signal generator circuit 82 for inputting the R-phase current control signal Vᵢᵣ, and another input connected to the periodic wave generator 74, FIG. 3, for inputting the periodic wave V₇₄. The S- and T-phase comparators 83_{b} and 83_{c}, are connected respectively to the proportional integrators 61 and 62, FIG. 3, for inputting the S- and T-phase current control signal signals Vᵢₛ and Vᵢₜ on one hand and, on the other, to the periodic wave generator 74 by way of the line 81. Thus the R-, S- and T-phase comparators 83ₐ, 83_{b} and 83_{c} put out the pulse-width-modulated ac-to-dc converter control signals Gᵣ, Gₛ, and Gₜ which go high (logic one) when the current control signals Vᵢᵣ, Vᵢₛ and Vᵢₜ are higher than the triangular or sawtoothed periodic wave V₇₄, and low (logic zero) when the current control signals are lower than the periodic wave.

FIG. 5 also shows in detail the first driver circuit 18 connected between ac-to-dc converter control signal generator circuit 63 and ac-to-dc converter circuit 3, FIGS. 1 and 2. The first driver circuit 18 comprises:

1. An R-phase drive amplifier 84ₐ and R-phase inverter circuit 84_{b} both having inputs connected to the R-phase comparator 83ₐ of the ac-to-dc converter control signal generator circuit 63 by way of the line 30ₐ, and outputs connected respectively to the gates of the first and second ac-to-dc conversion switches Q₁ and Q₂ of the ac-to-dc converter circuit 3.

2. An S-phase drive amplifier 84_{c} and S-phase inverter circuit 84_{d} both having inputs connected to the S-phase comparator 83_{b} of the ac-to-dc converter control signal generator circuit 63 by way of the line 30_{b}, and outputs connected respectively to the gates of the third and fourth ac-to-dc conversion switches Q₃ and Q₄ of the ac-to-dc converter circuit 3.

3. A T-phase drive amplifier 84ₑ and T-phase inverter circuit 84_{f} both having inputs connected to the T-phase comparator 83_{c} of the ac-to-dc converter control signal generator circuit 63 by way of the line 30_{c}, and outputs connected respectively to the gates of the fifth and sixth ac-to-dc conversion switches Q₅ and Q₆ of the ac-to-dc converter circuit 3.

4. A first selective drive switch S₁ connected between R-phase drive amplifier 84ₐ and ac-to-dc conversion switch Q₁.

5. A second selective drive switch S₂ connected between R-phase inverter circuit 84_{b} and ac-to-dc conversion switch Q₂.

Thus the R-phase drive amplifier 84ₐ and R-phase inverter circuit 84_{b} apply the width-modulated ac-to-dc converter control pulses between the gate and emitter of the first and second ac-to-dc conversion switches Q₁ and Q₂ via the selective drive switches S₁ and S₂ only when the bypass switch 8 is open. The S-phase drive amplifier 84, and S-phase inverter circuit 84_{d} apply the width-modulated ac-to-dc converter control pulses between the gate and emitter of the third and fourth ac-to-dc conversion switches Q₃ and Q₄. The T-phase drive amplifier 84ₑ and T-phase inverter circuit 84_{f} apply the width-modulated ac-to-dc converter control pulses between the gate and emitter of the fifth and sixth ac-to-dc conversion switches Q₅ and Q₆.

Under the control of the bypass switch control signal on the line 41ₐ, which of course indicates whether the bypass switch 8 is on or off, the selective drive switches S₁ and S₂ are both open when the bypass switch is closed, and vice versa. The first and second ac-to-dc conversion switches Q₁ and Q₂ are therefore held open during the conducting periods of the bypass switch 8, and only the third to sixth ac-to-dc conversion switches Q₃-Q₆ are driven by the width-modulated control pulses.

The third to sixth ac-to-dc conversion switches Q₃-Q₆ function to approximate the S- and T-phase ac input currents Iₛ and Iₜ from the inputs 1_{b} and 1_{c} to sinusoidal waves. The R-phase ac input current Iᵣ becomes sinusoidal of necessity if the S- and T-phase ac input currents Iₛ and Iₜ are both sinusoidal, because Iᵣ=−(Iₛ+Iₜ). The R-phase first and second ac-to-dc conversion switches Q₁ and Q₂ are therefore both held open while the bypass switch 8 is closed.

When the bypass switch 8 is open, on the other hand, the two selective drive switches S₁ and S₂ are both closed, with the result that all the six switches Q₁-Q₆ of the ac-to-dc converter circuit 3 are conventionally driven by the width-modulated control pulses for improvements in both waveform and power factor. The provision of the selective drive switches S₁ and S₂ is not essential; instead, all the ac-to-dc conversion switches Q₁-Q₆ may be driven irrespective of whether the bypass switch 8 is open or closed.

The dc voltage V_{dc}, FIG. 1, across the capacitor 6 is approximately constant since the ac-to-dc converter control circuit 36 is capable of dc voltage control. The capacitor 6 may be of sufficiently large capacitance to serve as dc power supply. This capacitance may be lessened, however, by incorporating into the FIG. 1 circuitry the known means for the so-called soft-switching of the ac-to-dc conversion switches Q₁-Q₆ and dc-to ac conversion switches Qₐ-Q_{f}.

Referring once again to FIG. 3, the dc-to-ac converter control circuit 37 of the control circuit 17 comprises, for controlling the dc-to-ac converter circuit 7, FIG. 1, via the second driver circuit 19:

1. A memory 64 for providing three-phase reference sinusoidal wave voltages Vᵣ₁, Vᵣ₂ and Vᵣ₃ at prescribed timings determined by the bypass switch control and phase select circuit 35.

2. Three gain control circuits 65, 66 and 67 connected to the memory 64 for inputting the respective reference sinusoidal wave voltages Vᵣ₁, Vᵣ₂ and Vᵣ₃.

3. Three subtractors 68, 69 and 70 connected respectively to the gain control circuits 65-67 on one hand and, on the other, to the three-phase output voltage detect signal lines 27-29.

4. Three proportional integrators 71, 72 and 73 connected respectively to the subtractors 68-70 for providing voltage control signals V₁, V₂ and V₃.

5. An dc-to-ac converter control signal generator circuit 75 connected to the proportional integrators 71-73 and the periodic wave generator 74 for generating width-modulated dc-to-ac converter control pulse signals G₁, G₂ and G₃, which are to be delivered over the lines 32-34 to the second driver circuit 19, FIG. 1, in order to cause the same to drive the switches Qₐ-Q_{f}, FIG. 2, of the dc-to-ac converter circuit 7 accordingly.

The memory 64 of the dc-to-ac converter control circuit 37 has stored therein data representative of the three-phase reference voltages Vᵣ₁, Vᵣ₂ and Vᵣ₃ of sinusoidal waveform and put them out on lines 76, 77 and 78 in prescribed phase relationship. The reference sinusoidal voltages Vᵣ₁, Vᵣ₂ and Vᵣ₃ are themselves three-phase ac voltages having phase differences of 120 degrees from one another. Further, for timing these voltage signals to the phase signal θ, (F) in FIG. 6, the memory 54 has an input connected to the phase signal output line 53, FIG. 4, of the bypass switch control and phase select circuit 35. Thus the memory 54 puts out the three-phase voltages Vᵣ₁, Vᵣ₂ and Vᵣ₃ in synchronism with the phase signal θ which as aforesaid may be either ac input phase signal θ₁ or target output phase signal θ₂. Means other than a memory might be adopted for providing the reference sinusoidal waves in prescribed phase relationship.

The output lines 76-78 of the memory 64 are connected respectively to the gain control circuits 65-67. These circuits 65-67 process the incoming reference voltages Vᵣ₁, Vᵣ₂ and Vᵣ₃ for phasing the three-phase ac input voltages and three-phase ac output voltages.

The gain control circuits 65-67 have their outputs connected respectively to the subtractors 68-70, which are also connected to the output lines 27-29 of the voltage detector 16, FIG. 1, for inputting the three-phase ac output voltages Vₐ, V_{b} and V_{c}. Outputs from the subtractors 68-90 are therefore indicative of differences between the gain-adjusted reference voltages Vᵣ₁, Vᵣ₂ and Vᵣ₃ and the detected ac output voltages Vₐ, V_{b} and V_{c}.

Smoothing these difference signals from the subtractors 68 and 70, the proportional integrators 71-73 provide the output voltage control signals V₁-V₃ on their output lines 88-90 leading to the dc-to-ac converter control signal generator circuit 75. The proportional integrators 71-73 might be of one-piece construction with the subtractors 68-70. Further, here again, adders might be substituted for the subtractors 68-70, and signals of opposite polarities input to these adders.

The output lines 88-90 of the proportional integrators 71-73 are all connected to the dc-to-ac converter control signal generator circuit 75 to which is also connected the output line 91 of the noted periodic wave generator 74. Comparing the period wave V₇₄ from its generator 74 and the voltage control signals V₁-V₃ from the proportional integrators 71-73, the dc-to-ac converter control signal generator circuit 75 provides the three-phase dc-to-ac conversion control signals G₁, G₂ and G₃ on its output lines 32-34 leading to the second driver circuit 19, FIG. 1.

As illustrated in detail in FIG. 5, the dc-to-ac converter control signal generator circuit 75 comprises three comparators 92, 93 and 94 connected respectively to the proportional integrators 71-73, FIG. 3, by way of the lines 88-90 for inputting the output voltage control signals V₁-V₃ on one hand and, on the other, to the periodic wave generator 74 by way of the line 91 for inputting the periodic wave V₇₄. The outputs G₁-G₃ from the comparators 92-94 are therefore high when the voltage control signals V₁-V₃ are higher than the periodic wave V₇₄, and low when they are lower.

FIG. 5 also shows in detail the driver circuit 19 for the dc-to-ac converter circuit 7, FIGS. 1 and 2. The driver circuit 19 comprises, for conventionally turning the first, third and fifth switches Qₐ, Q_{c} and Qₑ, FIG. 2, of the dc-to-ac converter circuit 7 in alternation with its second, fourth and sixth switches Q_{b}, Q_{d} and Q_{f}:

1. An R-phase drive amplifier 95 and R-phase inverter circuit 96 both having inputs connected to the R-phase comparator 92 of the dc-to-ac converter control signal generator circuit 75 by way of the line 32, and outputs connected respectively to the gates of the first and second dc-to-ac conversion switches Qₐ and Q_{b}.

2. An S-phase drive amplifier 97 and S-phase inverter circuit 98 both having inputs connected to the S-phase comparator 93 of the dc-to-ac converter control signal generator circuit 75 by way of the line 33, and outputs connected respectively to the gates of the third and fourth dc-to-ac conversion switches Q_{c} and Q_{d}.

3. A T-phase drive amplifier 99 and T-phase inverter circuit 100 both having inputs connected to the T-phase comparator 94 of the dc-to-ac converter control signal generator circuit 75 by way of the line 34, and outputs connected respectively to the gates of the fifth and sixth dc-to-ac conversion switches Qₑ and Q_{f}.

### Operation

The waveform diagram of FIG. 6 is drawn on the assumption that a difference between the target output frequency fᵣ, (A) in this figure, and the detected input frequency f₁, (C), has been either zero or negligibly small (that is, the three-phase ac input voltages have been substantially in phase with the output voltages) until the moment t₃. The bypass switch control signal V₄₀, (E) in FIG. 6, from the comparison means 40, FIG. 4, is then high, holding the bypass switch 8, FIGS. 1 and 2, closed.

It will also be noted by referring back to FIG. 4 that the high output from the comparison means 40 has held the first switch 50 of the selector means 42 closed, and the second switch 51 open. Thus the ac input phase signal θ₁, rather than the target output phase signal θ₂, has been allowed through the selector means 42 until the moment t₃, for delivery to the memory 64, FIG. 3, of the dc-to-ac converter control circuit 37. The memory 64 has responded to the ac input phase signal θ by producing in synchronism therewith the data representative of the three reference sinusoidal voltages Vᵣ₁, Vᵣ₂ and Vᵣ₃ with the mutual phase differences of 120 degrees. The three-phase dc-to-ac converter circuit 7 has thus been driven in synchronism with the three-phase ac input voltages. Preferably, during such synchronous operation, the ac input voltages and output voltages should be approximately the same in amplitude.

With reference to FIG. 1, during the above synchronous operation of the dc-to-ac converter circuit 7, the effective R-phase current is fed to the load, not shown, by way of the path comprising the first ac input 1ₐ, bypass switch 8, and first ac output 2ₐ The effective current need not flow wholly through the first and second switches Qₐ and Q_{b}, FIG. 2, of the dc-to-ac converter circuit 7. These switches are used mostly for the flow of ineffective current. There is therefore less power loss, due to both switching and conduction losses, at the switches Qₐ and Q_{b} than at the other switches Q_{c}-Q_{f} of the dc-to-ac converter circuit 7.

As the input frequency f₁ grows higher than the target output frequency fᵣ at t₃ in FIG. 6, the output V₄₀ from the comparison means 40 will go low, indicating nonsynchronism, at t₅ after the unavoidable detection delay. The low output V₄₀ will turn the bypass switch 8 off, the first switch 50 of the selector means 42 off, and the second switch 51 of the selector means 42 on. The memory 64 of the dc-to-ac converter control circuit 37 will then put out the reference voltages Vᵣ₁-Vᵣ₃ in synchronism with the target output phase signal θ₂ from the integrator circuit 46, FIG. 4, of the bypass switch control and phase select circuit 35. Thereupon the dc-to-ac converter circuit 7 will become free-running, operating without constraint by the three-phase ac input voltages.

The foregoing explanation of operation has been limited to the case where the input frequency f₁ grows higher than the target output frequency fᵣ. It is considered self-evident, then, that the dc-to-ac converter circuit 7 becomes free-running when the input frequency f₁ gets lower than the target output frequency fᵣ.

The advantages gained by this particular embodiment of the invention may be recapitulated as follows:

1. Shown connected between first ac input terminal 1ₐ and first ac output terminal 2ₐ, the bypass switch 8 is closed when the three-phase ac input voltages are substantially in phase with the three-phase ac output voltages, causing the effective current of the R-phase to bypass both ac-to-dc converter circuit 3 and dc-to-ac converter circuit 7. The results are less power loss at the first and second switches Qₐ and Q_{b}, FIG. 2, of the dc-to-ac converter circuit 7 and a higher efficiency of the three-phase power converter.

2. The bypass switch 8 will open in the event of an abnormal change in input ac frequency, permitting the dc-to-ac converter circuit 7 to run freely for uninterrupted supply of the desired three-phase ac output voltages. The operation of the ac-to-dc converter circuit 3 is not interrupted, either, so that the dc voltages are continuously supplied from ac-to-dc converter circuit 3 to dc-to-ac converter circuit 7. Hence the non-outage three-phase power supply.

3. The first and second switches Q₁ and Q₂ of the ac-to-dc converter circuit 3 are held open when the bypass switch 8 is closed, because then the R-phase of the ac-to-dc converter circuit is not pulse-width modulated, so that no power loss is possibly to occur at these switches either.

4. The periodic wave generator 74, FIG. 3, is shared by the ac-to-dc converter control circuit 36 and dc-to-ac converter control circuit 37 for simpler, less expensive, more compact circuit configuration.

5. Simpler circuit configuration is also realized as only the S- and T-phase current detectors 10 and 11 are employed for production of the S- and T-phase current control signals Vᵢₛ and Vᵢₜ, the R-phase current control signal Vᵢᵣ being obtained by computation of −(Vᵢₛ+Vᵢₜ) by the R-phase current control signal generator circuit 82, FIG. 5, of the ac-to-dc converter control signal generator circuit 63.

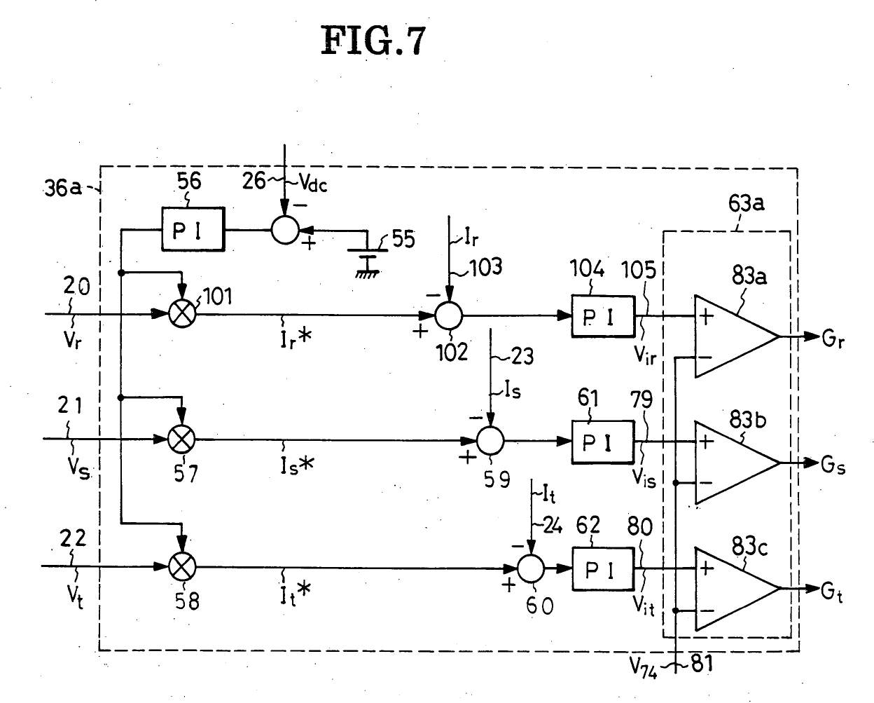

### Embodiment of FIG. 7

This alternate embodiment of the invention features a modified ac-to-dc converter control circuit 36ₐ for use in the three-phase power converter system of FIGS. 1-5 in substitution for the original ac-to-dc converter control circuit 36, FIG. 3. All the other details of construction are as previously set forth with reference to FIGS. 1-5 in conjunction with the first disclosed embodiment. A comparison of FIGS. 3 and 7 will reveal, however, that the modified ac-to-dc converter control circuit 36ₐ is constructed to input the detected R-phase input current Iᵣ for production of the R-phase current control signal V_{ir,} instead of creating this signal from the S- and T-phase current control signals Vᵢₛ and Vᵢₜ as in the ac-to-dc converter control signal generator circuit 63, FIG. 5, of the first embodiment. It is therefore understood that the modified ac-to-ac converter control circuit 36ₐ presupposes use of an R-phase current detector indicated by the broken lines in FIG. 1 and therein labeled 25.

Referring more specifically to FIG. 7, the modified ac-to-dc converter control circuit 36ₐ comprises an R-phase multiplier 101, R-phase subtractor 102, and R-phase proportional integrator 104, in addition to all the components of its FIG. 3 counterpart 36. The control signal generator circuit 63ₐ of the modified ac-to-dc converter control circuit 36ₐ also differs in construction from its FIG. 5 counterpart 63 as the R-phase current control signal Vᵢᵣ need not be generated internally.

The R-phase multiplier 101 has one input connected to the line 20 for inputting the R-phase input voltage detect signal Vᵣ, and another input to the proportional integrator 56. Thus the R-phase multiplier 101 puts out the R-phase target ac waveform signal Iᵣ* by modulating the amplitude of the incoming first phase voltage detect signal Vᵣ with the output from the proportional integrator 56.

The R-phase subtractor 102 has one input connected to the R-phase multiplier 101 and another input to a detected R-phase input current line 103. The output from this subtractor 102 is therefore indicative of the difference between R-phase target ac waveform signal Iᵣ* and R-phase input current detect signal Iᵣ. It is understood that the detected R-phase input current line 103 is coupled to the phantom R-phase current detector 25, FIG. 1, via a circuit analogous with the input current detector circuit 14.

Connected to the R-phase subtractor 102, the R-phase proportional integrator 104 provides the R-phase current control signal Vᵢᵣ on its output line 105 by smoothing the incoming difference signal. The subtractor 102 and proportional integrator 104 could be of integral construction. Further the subtractor 102 might be replaced by adder, provided that the input signals to the adder were made opposite in polarity.

The ac-to-dc converter control signal generator circuit 63ₐ is similar in construction to its FIG. 5 counterpart 63 except for the absence of the R-phase current control signal generator circuit 82. Thus the three comparators 83ₐ-83_{c} constituting this circuit 63ₐ are connected respectively to the proportional integrators 104, 61 and 62 on one hand and, on the other, to the periodic wave generator 74, FIG. 3, by way of the line 81. The resulting outputs from these comparators 83ₐ-83_{c} are therefore the pulse-width-modulated ac-to-dc converter control signals Gᵣ, Gₛ and Gₜ. These signals Gᵣ, Gₛ and Gₜ are to be applied to the first driver circuit 18, FIG. 1, in order to cause the same to drive the switches Q₁-Q₆, FIG. 2, of the ac-to-dc converter circuit 3 as in the first disclosed embodiment of the invention.

### Possible Modifications

Although the three-phase power converter according to the present invention has been shown and described hereinbefore in terms of but two currently preferred forms, it is understood that the invention may be embodied in a variety of other forms within the usual knowledge of the electrical and electronics specialists. The following is a brief list of possible modifications, alterations and adaptations of the illustrated embodiments which are all believed to fall within the scope of this invention:

1. The three-phase dc-to-ac converter circuit 7 may be made variable in either or both of its output frequency and output voltage. The bypass switch 8 may then be turned on only when this circuit 7 is capable of operation in synchronism with the three-phase ac input voltages.

2. The ac-to-dc converter control circuit 36, FIG. 3, could be connected to the phase detector 43, FIG. 4, instead of to the three-phase ac input voltage detector 13, FIG. 1. The phase detector 43 might then be made to put out both S- and T-phase signals or all of the R-, S- and T-phase signals.

3. The bypass switch 8 and the selector means 42, FIG. 4, could be controlled by different means for ascertaining synchronism, rather than by the same means 40. Use of different means would offer the advantage that the bypass switch 8 and the selector means 42 might be actuated at desired different moments in time.

4. The R-phase input current Iᵣ on the line 103, FIG. 7, might be detected by incorporating into the input current detector circuit 14, FIG. 1, means for calculating Iᵣ=−(Iₛ+Iₜ), rather than by using the phantom R-phase current detector of FIG. 1.

What is claimed is:

1. A three-phase ac-to-dc-to-ac power converter system with reduced power loss, comprising:
(a) a first, a second and a third ac input terminal for inputting a first-, a second- and a third-phase ac voltage;
(b) a first, a second and a third ac output terminal for outputting a first-, a second- and a third-phase ac voltage;
(c) a three-phase ac-to-dc converter circuit connected to the ac input terminals, the three-phase ac-to-dc converter circuit comprising a plurality of ac-to-dc conversion switches and a pair of outputs for providing a dc output voltage;
(d) storage means connected between the pair of outputs of the three-phase ac-to-dc converter circuit for storing output energy therefrom;
(e) a three-phase dc-to-ac converter circuit connected between the storage means and the ac output terminals, the three-phase dc-to-ac converter circuit comprising a plurality of dc-to-ac conversion switches for providing the three-phase ac output voltages;
(f) a bypass switch connected between a preselected one of the ac input terminals and a preselected one of the ac output terminals;
(g) ac-to-dc converter control means connected to the three-phase ac-to-dc converter circuit for controllably driving the ac-to-dc conversion switches thereof;
(h) dc-to-ac converter control means connected to the three-phase dc-to-ac converter circuit for controllably driving the dc-to-ac conversion switches thereof either in or out of synchronism with the three-phase ac input voltages; and
(i) bypass switch control means connected to the bypass switch for holding the bypass switch closed when the three-phase dc-to-ac converter circuit is being driven in synchronism with the three-phase ac input voltages, and open when the three-phase dc-to-ac converter circuit is being driven out of synchronism with the three-phase ac input voltages.

2. A three-phase ac-to-dc-to-ac power converter system as defined in claim 1, wherein the bypass switch control means comprises:
(a) input parameter detector means connected to at least one of the ac input terminals for providing an ac input parameter signal indicative of a preselected parameter of the corresponding phase ac input voltage;
(b) target output parameter generator means for providing a target output parameter signal indicative of a target value of the preselected parameter of the three-phase ac output voltages;
(c) comparison means connected to the input parameter detector means and the target output parameter generator means for comparing the ac input parameter signal and the target output parameter signal in order to determine whether the three-phase ac input voltages are in or out of synchronism with the three-phase ac output voltages, the comparison means outputting a bypass switch control signal for closing the bypass switch when the three-phase ac input voltages are in synchronism with the three-phase ac output voltages, and opening the bypass switch when the three-phase ac input voltages are out of synchronism with the three-phase ac output voltages.

3. A three-phase ac-to-dc-to-ac power converter system as defined in claim 2, wherein the input parameter detector means of the bypass switch control means comprises:
(a) a phase detector for providing an ac input phase signal; and
(b) a differentiating circuit connected to the phase detector for providing an ac input frequency signal.

4. A three-phase ac-to-dc-to-ac power converter system as defined in claim 2, wherein the target output parameter generator means of the bypass switch control means comprises:
(a) a frequency generator for providing a target output frequency signal; and
(b) an integrating circuit connected to the frequency generator for providing a target output phase signal.

5. A three-phase ac-to-dc-to-ac power converter system as defined in claim 2, wherein the power converter system further comprises selector means responsive to the bypass switch control signal from the comparison means for selectively passing the ac input parameter signal from the input parameter detector means and the target output parameter signal from the target output parameter generator means according to whether the three-phase ac input voltages are in or out of synchronism with the three-phase ac output voltages, the selected ac input parameter signal or target output parameter signal being delivered to the dc-to-ac converter control means.

6. A three-phase ac-to-dc-to-ac power converter system as defined in claim 5, wherein the dc-to-ac converter control means comprises:
(a) reference wave generator means connected to the selector means for providing a set of three sinusoidal reference waves in prescribed time relationship to the incoming ac input parameter signal or target output parameter signal;
(b) a three-phase ac output voltage detector connected the output terminals for providing ac output detect signals indicative of the three-phase ac output voltages;
(c) subtractor means connected to the reference wave generator means and the ac output voltage detector for providing difference signals indicative of differences between the sinusoidal reference waves and the ac output detect signals;
(d) a periodic wave generator for providing a periodic wave signal which is higher in frequency than the sinusoidal reference waves; and
(e) a dc-to-ac converter control signal generator circuit connected to the subtractor means and the periodic wave generator for providing pulse-width-modulated dc-to-ac converter control signals by comparison of the difference signals and the periodic wave signal, thereby to drive the dc-to-ac conversion switches of the three-phase dc-to-ac converter circuit.

7. A three-phase ac-to-dc-to-ac power converter system as defined in claim 1, wherein the ac-to-dc converter control means comprises:
(a) a three-phase ac input voltage detector connected to the ac input terminals for providing three-phase ac input voltage detect signals indicative of the three-phase ac input voltages;
(b) a dc voltage detector connected to the storage means for providing a dc voltage detect signal indicative of a dc voltage across the same;
(c) a source of a reference voltage indicative of a target value of the dc voltage across the storage means;
(d) first subtractor means connected to the dc voltage detector and the reference voltage source for providing a first difference signal indicative of a difference between the actual and target values of the dc voltage across the storage means;
(e) a first multiplier connected to the three-phase ac input voltage detector and the first subtractor means for providing a first product signal indicative of the product of multiplication of the second-phase ac input voltage detect signal and the first difference signal;
(f) a second multiplier connected to the three-phase ac input voltage detector and the first subtractor means for providing a second product signal indicative of the product of multiplication of the third-phase ac input voltage detect signal and the first difference signal;
(g) current detector means for providing a first and a second ac input current detect signal indicative respectively of second- and third-phase currents flowing through the second and third ac input terminals;
(h) second subtractor means connected to the first multiplier and the current detector means for providing a second difference signal indicative of a difference between the first product signal and the first ac input current detect signal;
(i) third subtractor means connected to the second multiplier and the current detector means for providing a third difference signal indicative of a difference between the second product signal and the second ac current detect signal;
(j) a periodic wave generator for providing a periodic wave signal which is higher in frequency than the second- and third-phase ac input voltage detect signal; and
(k) an ac-to-dc converter control signal generator circuit connected to the second and the third subtractor means and the periodic wave generator for providing a first, a second and a third pulse-width-modulated ac-to-dc converter control signal by comparison of the difference signals and the periodic wave signal, thereby to drive the ac-to-dc conversion switches of the three-phase ac-to-dc converter circuit.

8. A three-phase ac-to-dc-to-ac power converter system as defined in claim 1, wherein the converter system further comprises a first, a second and a third inductor connected respectively between the first, the second and the third ac input terminal and the three-phase ac-to-dc converter circuit, and wherein the ac-to-dc converter circuit further comprises:
(a) a first diode having an anode connected to the first ac input terminal via the first inductor and a cathode connected to the storage means;
(b) a second diode having an anode connected to the storage means and a cathode connected to the first ac input terminal via the first inductor;
(c) a third diode having an anode connected to the second ac input terminal vie the second inductor and a cathode connected to the storage means;
(d) a fourth diode having an anode connected to the storage means and a cathode connected to the second ac input terminal vie the second inductor;
(e) a fifth diode having an anode connected to the third ac input terminal via the third inductor and a cathode connected to the storage means; and
(f) a sixth diode having an anode connected to the storage means and a cathode connected to the third ac input terminal via the third inductor.

9. A three-phase ac-to-dc-to-ac power converter system as defined in claim 8, wherein the ac-to-dc conversion switches of the three-phase ac-to-dc converter circuit are comprised of a first, a second, a third, a fourth, a fifth and a sixth ac-to-dc conversion switch which are connected respectively in parallel with the first, the second, the third, the fourth, the fifth and the sixth diode, and wherein the power converter system further comprises selective drive means connected to the ac-to-dc converter control means for permitting the same to drive the third, the fourth, the fifth and the sixth ac-to-dc conversion switch of the three-phase ac-to-dc converter circuit, and to hold the first and the second ac-to-dc conversion switch open, when the bypass switch is closed, and to drive all of the first to the sixth ac-to-dc conversion switch of the three-phase ac-to-dc converter circuit when the bypass switch is open.
